(19) United States
(12) Patent Application Publication
(10) Pub. No.: US 2014/0282266 A1
(43) Pub. Date: Sep. 18, 2014

(54) PROVIDING INFORMATION REGARDING CONSUMABLE ITEMS TO USERS

(71) Applicant: APPLIED INFORMATION LLC, Corbin, KY (US)

(72) Inventors: Robert Brown, Corbin, KY (US); Herman Adams, London, KY (US)

(73) Assignee: APPLIED INFORMATION LLC, Corbin, KY (US)

(21) Appl. No.: 13/826,035

(22) Filed: Mar. 14, 2013

(51) Int. Cl. G06F 3/0481

(52) U.S. Cl. CPC G06F 3/04815
USPC 715/848

(57) ABSTRACT

Various embodiments are directed to systems and methods for characterizing consumable items. A computer system receives a plurality of characteristics describing a first consumable item. The computer system derives first, second and third dimension values from respective first, second and third sets of the plurality of characteristics. The computer system generates a user interface, where the user interface depicts a three-dimensional space and comprises an icon representing the first consumable item. Generating the user interface comprises positioning the icon in the depicted three-dimensional space at a position corresponding to the first, second and third dimension values.

### BACKGROUND

The wine industry is currently booming, with the market for wine continuing to grow and expand all over the world. Today, there are more than 4000 grape varieties grown in countries all over the world on more than 20 million acres. In the United States alone, the wine industry is comprised of more than 7900 wineries generating more than $5 billion in sales. Despite the size of the market, there is still are still serious shortcomings in the commonly used methods for characterizing wines.

Known methods for evaluating and recommending wines typically rely on ratings provided by various wine critics or groups of critics. The ratings are typically indicated by a single value on a linear scale with differing, and often inadequate levels of granularity. For example, one scale introduced by wine critic Robert Parker in the mid-1970's, includes values from 50-100. Other scales, used by critics such as Jancis Robinson and Michael Broadbent, include values from 0-20. Still other scales include values from 0-4 or 0-5, typically represented as a number of stars. Ratings on scales such as these can be a mix of extremely subjective and incomplete, without much reference as to meaning.

Since different individuals typically do not taste a wine the same way, these ratings leave consumers with limited information as to how a given wine actually tastes and, therefore, little way of knowing whether the consumer will enjoy a particular wine. For example, traditional wine ratings only indicate the quality of a wine and limited in the ability to specify how a wine is good or bad, the flavor of a wine, the sweetness (or dryness) of a wine, the aroma of a wine, etc., relative to other wines. There is a need for improvements to represent a more complete picture of different wines. Similar needs exist with respect to other subjectively-evaluated consumable items, such as food, spirits, beer, etc.

### DRAWINGS

STATEMENT UNDER 37 C.F.R. §1.84(a)(2): The patent or application file contains at least one drawing executed in color. Copies of this patent or patent application publication with color drawings will be provided by the Office upon request and payment of the necessary fee.

Various example embodiments are described herein by way of example in conjunction with the following figures, wherein:

FIG. 1 is a block diagram illustrating one embodiment of an environment for generating and serving user interfaces characterizing consumable items.

FIG. 2 is a flow chart illustrating one embodiment of a process flow that may be executed in the environment to generate and serve user interfaces characterizing consumable items.

FIG. 3 is a diagram illustrating one embodiment of a workflow for generating a user interface characterizing consumable items.

FIG. 4 is a screen shot showing one embodiment of an interface screen comprising a metadata field.

FIG. 5 is a diagram illustrating one embodiment of a relationship between dimension values and three-dimensional space.

FIG. 6 is a diagram illustrating a relationship between dimension values and three-dimensional space depicted on a two-dimensional view, such as a two-dimensional screen of a user device.

FIG. 7 is diagram showing another embodiment of the relationship indicated by FIG. 6.

FIGS. 8-10 illustrate additional embodiments of an interface with various icons plotted thereon according to the relationship indicated by FIGS. 5-7.

FIG. 11 is a diagram illustrating another embodiment of a relationship between dimension values and the three-dimensional space.

FIG. 12 is a diagram illustrating yet another embodiment of a relationship between dimension values and three-dimensional space.

FIG. 13 is a flow chart illustrating one embodiment of a process flow that may be executed in the environment of FIG. 1 to generate and serve a user interface comparing multiple consumable items.

FIGS. 14 and 15 are diagrams showing embodiments of an interface showing icons in the three dimensional space representing multiple consumable items.

FIG. 16 is a flow chart showing one embodiment of a process flow that may be executed in the environment 100 to perform a search based on a consumable item.

FIG. 17 is a diagram illustrating one embodiment of an interface indicating results of a comparative search.

FIG. 18 is a diagram illustrating one embodiment of an interface showing an icon having a characteristic (e.g., aroma) represented by icon color.

FIG. 19 is a diagram showing one embodiment of an interface plotting the icon of FIG. 18.

FIGS. 20-23 are diagrams showing additional embodiments of the interface of FIG. 18 showing icons having characteristics (e.g., aroma) represented by an icon color.

FIGS. 24-25 are diagrams illustrating one embodiment of an additional interface 400 for providing information regarding consumable items to users.

FIG. 26 is a diagram illustrating one embodiment of yet another interface for providing information regarding consumable items to users.

### DESCRIPTION

Various embodiments are directed to systems and methods for generating and serving user interfaces for characterizing consumable items in a visual, multi-dimensional format. A consumable item, such as a wine, is described by a plurality of characteristics, which may include objective and subjective characteristics. A first dimension value is derived from a first set of the characteristics; a second dimension value is derived from a second set of the characteristics; and a third dimension value is derived from a third set of the characteristics. The first, second and third dimension values collectively represent a point in three-dimensional space. For example, the first, second and third dimension values may represent a radial distance, angular position, and offset as described herein. Also, in some embodiments, the first, second and third dimension values represent coordinate values for various three-dimensional coordinate systems including, for example, a radial distance, azimuth angle and height in a cylindrical coordinate system, a radius, inclination angle and azimuth angle in a spherical coordinate system, etc.

A user interface is generated for characterizing the consumable item based on the first, second and third dimension values. For example, the user interface may depict a three-dimensional space, either in three dimensions (e.g., utilizing a holographic projector or other three-dimensional display) or as a two-dimensional approximation. An icon corresponding to the consumable item may be plotted on the three-dimensional space at a position indicated by the first, second and third dimension values. Additional characteristics of the consumable item may be represented by the size of the icon, the color of the icon, the shape of the icon, etc.

The user interfaces described herein may be generated and served to users in any suitable manner. For example, characteristics of various consumable items are collected and stored at a consumable item database. Objective characteristics are observed or measured. Subjective characteristics may be measured by one or more individuals, referred to herein as evaluators, and rated according to a predetermined scale, as described herein. The resulting characteristics may be normalized and mapped to the respective dimension values. The specific characteristic or characteristics selected for mapping to any given dimension value may be selected in any suitable manner. For example, like or similar characteristics (e.g., aroma and flavor) may be considered together. Also, for example, one or more of the dimension values may be determined utilizing objective characteristics exclusively, while the remaining dimension values are determined utilizing subjective characteristics only.

The interfaces described herein may be utilized to provide various services to users. For example, in some embodiments, users may utilize the interfaces described herein to compare more than one consumable item. Dimension values may be derived for each consumable item. Icons for the respective consumable items are plotted on the three-dimensional space, allowing users to compare the consumable items. Also, in some embodiments, the user interfaces described herein may be utilized in the context of searches for consumable items. For example, a user may desire to identify consumable items similar to a known consumable item (e.g., a wine-enthusiast may desire to identify a bottle of wine similar to a vintage that the user already likes). Based on the user's selection of a first consumable item, additional consumable items may be identified and displayed as icons on the interface. The additional consumable items may be selected based on similarities to the characteristics of the first consumable item and/or based on similarities of the corresponding dimension values (e.g., how close the items plot onto the three-dimensional space). Results may be provided to the user through the interface.

Reference will now be made in detail to several example embodiments, examples of which are illustrated in the accompanying figures. Wherever practicable, similar or like reference numbers may be used in the figures and may indicate similar or like functionality. The figures depict example embodiments of the disclosed systems (or methods) for purposes of illustration only. One skilled in the art will readily recognize from the following description that alternative example embodiments of the structures and methods illustrated herein may be employed without departing from the principles described herein. Although the examples provided herein, including example interfaces and characteristics, describe wine, it will be appreciated that the systems and methods herein may be generally applicable to any type of consumable item and/or any type of item characterized by both objective and subjective values.

FIG. 1 is a block diagram illustrating one embodiment of an environment 100 for generating and servicing user interfaces characterizing consumable items. The environment 100 comprises user devices 102 for presenting the interfaces to users 103. The environment 100 also comprises various other systems that may contribute to the creation and population of the interfaces including, for example, one or more service provider systems 104, one or more testing systems 108, one or more evaluator systems 110 and one or more other systems 114.

Each user device 102 may be associated with a user 103. For example, a user 103 may own, lease, or otherwise have rights to use his or her associated user device 102. User devices 102 may comprise any type of network-enabled computer device that may be utilized by a user to receive and/or view interfaces as described herein. Examples of user devices include smart phones, tablet computers, laptop computers, desktop computers, computer-operated kiosks for placement at trade shows or retail locations, etc. In some embodiments, user devices 102 are configured with databases of consumable item characteristics and may be programmed to generate and serve the various user interfaces described herein to users 103. In other embodiments, the user devices 102 may receive all or portions of the various interfaces from one or more service provider systems 104. Some or all of the user devices 102 are associated with holographic projectors or other devices capable of rendering the user interfaces described herein in three dimensions.

Service provider systems 104 are programmed to generate and serve all or portions of the interfaces described herein. In various embodiments, service provider systems 104 comprises a data store 109, that may include a consumable item database comprising characteristics (e.g., objective and subjective) of different consumable items. Although the service provider system 104 is shown in FIG. 1 as a single block, it will be appreciated that the service provider system 104 may be and/or comprise a distributed processing system comprising multiple pieces of computer hardware distributed geographically and/or according to network topography. For example, the service provider system 104 may be configured to provide the interfaces as a generally-accessible cloud service, software-as-a-service (SaaS) or according to any similar and suitable method. In some embodiments, the service provider system 104 operates a subscription service. Users 103 (utilizing user devices 102) log-in to the service provider system 104 to receive the interfaces. Various users 103 and/or user devices 102 may have accounts with the service provider system 104, allowing the users 103 to view interfaces comprising information items specific to the user. The various components 102, 104, 108, 110, 111, 112, 114, etc. of the environment 100 may communicate with one another via a network 116. The service provider system 104 is in communication with a data store 109. The data store 109 may comprise characteristics of various consumable items, pre-calculated interface parameters, such as dimension values, etc.

One or more testing systems 108 may be configured to measure objective characteristics of consumable items, as described herein. For example, testing systems 108 may comprise and/or be in communication with various equipment for making objective measurements. Examples of such equipment include, various sensors for sensing color, the levels of various chemicals such as sulfur dioxide (SO2) and carbon dioxide (CO2), acidity, alcohol percentage, etc. In some embodiments, the testing systems 108 may be omitted. Objective characteristics may be measured, for example, manually and provided to the service provider system 104 and/or user devices 102 by any suitable method. One or more evaluator systems 110 may be utilized by evaluators 105 to providing values for subjective characteristics. For example, one or more evaluators may review the consumable items (e.g., eat or drink them) and provide values for various subjective characteristics to the evaluator system 110 via any suitable input/output interface. The evaluator systems 110 may provide the entered characteristics to the service provider system 104 and/or a user device 102, where the interfaces may be generated and served to users 103. Various other systems may be included in the environment 100 and may provide data useful for generating the user interfaces described herein. These systems are represented in FIG. 1 as an Other System 114. One example of an Other System 114 is a commercial database of consumable items. In the context of wines, such a database may describe different vintages, including associated wineries, grape varieties, etc. The network 116 may be any suitable type of wired, wireless, or mixed network and may comprise, for example, the Internet, a local area network (LAN), a wide area network (WAN), etc.

FIG. 2 is a flow chart illustrating one embodiment of a process flow 200 that may be executed in the environment 100 to generate and serve user interfaces characterizing consumable items. Optionally, at 202, a user 103 is authenticated by the service provider system 104. For example, the service provider system 104 prompts a user device 102 associated with the user 103. In response, the user 103 provides log-in information that is transmitted to the service provider system. In some embodiments, the authentication 202 is omitted. For example, authentication may be omitted when the user interfaces are generated by the user device 102 itself. Also, for example, the authentication may be omitted when the user interfaces are generally available and not part of a subscription service.

At 204, the service provider system 104 and/or user device 102 receives a request from the user 103 for a user interface. The request may specify properties of the desired interface. For example, in some embodiments, the user 103 may indicate a particular consumable item to be plotted on the user interface. In addition, or instead, the user 103 may indicate a characteristic or characteristics of consumable items to be plotted on the interface. In some embodiments, the user 103 may indicate other search terms for identifying a consumable item to be plotted on the interface. When search terms are included, searches for identifying consumable items for placement in the appropriate interfaces may be conducted by the service provider system 104 or user device 102, for example, as described in more detail below.

At 206, the service provider system 104 and/or user device 102 generates the requested user interface, for example, as described herein. In some embodiments, the user interfaces may be not generated on the fly for every request. Instead, the service provider system 104 may look-up pre-calculated dimension values for the selected consumable item or items, which may be stored at data store 104. When the interface is generated at a user device 102, the user device 102 may, at 208, receive the pre-calculated dimension values either from its own internal data store or from the service provider system 104. The generated interface is served to the user 103 at 210. At 212, the user device 102 and/or service provider service 104 may modify the served interface in response to an additional user request. For example, the user 103 may request that an additional consumable item be plotted in addition to or instead of the originally plotted consumable item.

FIG. 3 is a diagram illustrating one embodiment of a workflow 214 for generating a user interface characterizing consumable items. The workflow 214 receives as input objective characteristics 216 and subjective characteristics 218 of a consumable item to be plotted. Objective characteristics 216 are characteristics that can be directly measured and/or having values that are not subject to reasonable disagreement. Table 1 below describes example objective characteristics that may be utilized in some embodiments when the consumable item is wine:

TABLE 1
EXAMPLE OBJECTIVE CHARACTERISTICS FOR WINE

| Characteristic | Description |
|---|---|
| Vintage | A time, for example, a year when the |
| | constituent grapes were harvested. |
| Wine Type | A description of the grapes and/or strain of |
| | yeast used to make a wine. Wine type may |
| | be expressed on a scale of 1 to X and plotted |
| | graphically to illustrate variation. |
| Grape Variety 1 | A first variety of grapes used. This |
| | characteristic may be plotted on a scale of 1 |
| | to X. |
| Grape Variety 2 | A second variety of grapes used. This |
| | characteristics may be plotted on a scale of 1 |
| | to X. |
| Variety Mix | For mixed wines, a percentage of different |
| | grape varieties utilized. |
| Brix°/Residual Sugar | An indication of sugar content. In some |
| | embodiments, brix values are represented on |
| | a logarithmic scale so as to illustrate |
| | variation. |
| Alcohol Percentage | A percentage of the wine that is alcohol. In |
| | some embodiments, alcohol percentage |
| | values are represented on a logarithmic scale |
| | so as to illustrate variation. |
| PH° | A measurement of the degree of relative |
| | acidity versus relative alkalinity of the |
| | consumable item. PH values may be |
| | measured on a scale of 0-14, with 7 being |
| | neutral, 14 being most basic and 0 being most |
| | acidic. Most wine PH values fall around 3 or |
| | 4. About 3.0-3.4 is often considered best for |
| | white wines while about 3.3-3.6 is often |
| | considered best for red wines. |
| Acidity°/Volatile Acid | An indication of the acidity of the wine. In |
| | some embodiments, acidity is represented on |
| | a logarithmic scale so as to illustrate |
| | variation. |
| TA°/Tartic Acid | A total acidity of the wine, expressed by |
| Equivalents | volume. In some embodiments, TA is |
| | represented on a logarithmic scale so as to |
| | illustrate variation. |
| SO2 Level | A level of sulfur dioxide in the wine. In some |
| | embodiments, SO2 levels are represented on |
| | a logarithmic scale so as to illustrate |
| | variation. |
| CO2 Level | A level of carbon dioxide in the wine. In |
| | some embodiments, CO2 levels are |
| | represented on a logarithmic scale so as to |
| | illustrate variation. |

Any combination of objective characteristics may be utilized including more, fewer and/or different combinations of those listed in Table 1. For example, additional characteristics may include color or color distribution, as measured by a spectrometer, aroma related variables as measured by an olfactory sensor, etc. Objective characteristics may be measured and reported to the service provider system 104 and/or user device 102 via a testing system 108 and/or may be measured and entered directly to the service provider system 104 or user device 102.

Subjective characteristics 218 include characteristics of consumable items that cannot be objectively measured. Example subjective characteristics that may be utilized in some embodiments when the consumable item is wine include, aroma, appearance, color, flavor, dryness, sweetness/sugar, texture, astringency, body, acidity, finish, balance, etc. In various embodiments, the subjective characteristics are gathered in a manner so as to minimize palette-related variations. For example, evaluators 105 may rate the subjective characteristics of a wine or other consumable item according to a linear and/or progressive measurement scale. In some embodiments, multiple evaluators 105 are used so as to reduce the effects of individual palette-related deviations. Table 2 below comprises a list of the example characteristics from above along with corresponding example measurement scales.

TABLE 2
EXAMPLE SUBJECTIVE CHARACTERISTICS FOR WINE

| Characteristic | Measurement Scale |
|---|---|
| Aroma | An aroma value may be assigned on a scale between 0.0 and |
| | 8.6, with different values corresponding to different levels of |
| | different kinds of aromas present in the wine. Example aromas |
| | plotted on the scale include, tree fruit, tropical fruit, phenolic, |
| | caramel, etc. |
| Appearance/Translucence | An appearance or translucence value may be plotted on a |
| | progressive linear scale, for example, with values ranging from |
| | 1.0 to 10. |
| Color | A color value of a wine may be expressed on a progressive |
| | linear scale, for example, with values ranging from 1 to 14. |
| Flavor | A flavor value of a wine may be expressed on a linear scale |
| | corresponding, for example, to fruity, clean, full or balanced. In |
| | one example, the linear scale may take values from 1-10. |
| Dryness | Dryness make take various values including, for example, extra |
| | brut or brut naturale, brut dry, sec, demi, or doux. These values |
| | may be represented on a progressive linear scale of 1-10, with 1 |
| | representing extra brut and 10 represented doux. |
| Sweetness/Sugar | Sweetness may be represented by a value on a linear scale |
| | ranging from 1-10. |
| Texture | Texture may be represented by a value on a linear scale ranging |
| | from 1-10. |
| Astringency | Astringency may be represented by a value on a linear scale |
| | ranging from 1-10. |
| Body | Body may be represented by a value on a linear scale ranging |
| | from 1-10. |
| Acidity | Acidity may be represented by a value on a linear scale ranging |
| | from 1-10. |
| Finish | Finish may be represented by a value on a linear scale ranging |
| | from 1-10. |
| Balance | Balance may be represented by a value on a linear scale ranging |
| | from 1-10. |

It will be appreciated that the values shown in FIG. 2 are not a comprehensive list of the subjective characteristics that may be utilized for wine or any other suitable consumable item. For example, various embodiments utilize more, fewer and/or different combinations of those listed in Table 1. Also, the scales described above are but one example of scales that may be utilized for the associated subjective characteristics. Any suitable scale or scales may be used.

Referring back to FIG. 3, at 220, the service provider system 104 and/or user device 102 scale and/or normalize values for the respective objective and subjective characteristics. For example, characteristics measured and/or gathered on different scales may be normalized so as to be represented on a common scale. For example, referring to Table 1, the expected concentration of CO2 in a wine may be much smaller than the expected concentration of SO2. Accordingly, concentration values for CO2 and SO2 may be normalized to represent a percentage of the maximum expected values.

At 222, the service provider system 104 and/or the user device 102 may map selected characteristics to dimension values 224. The mapping may be performed according to any suitable method. In some embodiments, multiple characteristics are mapped to the same dimension value. For example, alcohol, PH°, and Brix° may be mapped to same dimension value. In some embodiments, similar characteristics may be mapped to common dimension values. For example, PH°, acidity° and TA° may be mapped together to one dimension value, as these characteristics are all related to the generally acidity of the consumable item. Characteristics mapped to a common dimension value may be combined in any suitable way using any suitable mathematical combination (e.g., average, addition, multiplication, etc.). For example, some characteristic values (e.g., characteristic values that are normalized and/or measured on a common scale) may be averaged. In some embodiments, users 103 may be provided with functionality to select the characteristics that are mapped to the dimension values.

Once derived, dimension values 224 may be utilized by the service provider system 104 and/or user device 102 to generate an interface 226. The interface 226, as described herein, may depict a three-dimensional space 232 with an icon 234 plotted therein. The three-dimensional space 232 may be depicted in two dimensions, e.g., on a flat screen, or may be depicted by a holographic projector or other three-dimensional display in three dimensions. The icon 234, and particularly its position within the three-dimensional space 232, represents the consumable item, as indicated by the objective and subjective characteristics mapped to the dimension values. In some embodiments, the interface 226 also comprises one or more metadata fields 230. Metadata fields, such as 230, show additional metadata 228 describing the consumable item. When the consumable item is a wine, the metadata 228 may include a wine name; a wine identification number; a winery of origin; a country of origin; a region of origin; an origin of the constituent grapes; an importer; comments; a date on which the objective characteristics were measured; a date or dates on which the subjective characteristics were measured; an identity of one or more evaluators 105 who generated the subjective characteristics; a map of the region in which the produce for generating the consumable item was raised; a picture of a bottle or container in which the consumable item was sold; notes, etc. In some embodiments, the metadata field 230 may also comprise values for some or all of the subjective and/or objective characteristics. Also, in some embodiments, the metadata field 230 may comprise ratings for a wine or other consumable item on other competing scales (e.g., for the user's reference). FIG. 4 is a screen shot showing one embodiment of an interface screen 236 comprising a metadata field 230.

The dimension values 224 may related to the three-dimensional space in any suitable manner. FIG. 5 is a diagram illustrating one embodiment of a relationship between dimension values and three-dimensional space 232. In FIG. 5, the three-dimensional space 232 is defined with reference to a set of mutually orthogonal axes x, y and z meeting at an origin 239. An icon 240 represents a consumable item. The position of the icon 240 is described by three dimension values, a radius R, an xy angle θ and an offset O. The radius R describes a distance between the z-axis and the icon 240. The xy angle θ describes an angle between the positive y-axis and the icon 240. The offset O describes a position of the icon 240 on the z-axis.

The dimension values, the radius R, the xy angle θ and the offset O, may be derived from various consumable item characteristics, for example, as described herein. For example, Tables 3-4 below illustrate one example for deriving the radius R, the xy angle θ and the offset O from an example set of consumable item characteristics for wine:

TABLE 3
EXAMPLE CHARACTERISTIC VALUES FOR A CONSUMABLE
ITEM (WINE)

| Characteristic | Value |
|---|---|
| Objective | |
| Alcohol Percentage | 13 (evaluated on a scale from 8.0-18.0) |
| PH° | 3.83 (evaluated on a scale from 2.0-4.0) |
| Brix° | 19.9 (evaluated on a scale from 12.0-22.0) |
| Subjective | |
| Aroma | 4.8 (evaluated on a scale from 0-8.6) |
| Flavor | 8.0 (evaluated on a scale from 0-10) |
| Balance | 8.0 (evaluated on a scale from 0-10) |

In this example, alcohol percentage, PH°, and Brix° are mapped to the radius R. The aroma is mapped to the xy angle θ. Flavor and balance are mapped to the offset O. Prior to mapping, the alcohol percentage, PH° and Brix° may be scaled and normalized as indicated by Equations (1)-(3) below:

$$\begin{matrix}NormalizedAlchohol \% = \frac{RawAlchohol \%}{ScaleRange} \times LogDiffFactor \times ScaleConv & ( 1 ) \\ NormalizedPH = \frac{RawPH}{ScaleRange} \times LogDiffFactor \times ScaleConv & ( 2 ) \\ Brix = \frac{RawBrix}{ScaleRange} \times LogDiffFactor \times ScaleConv & ( 3 )\end{matrix}$$

In Equations (1)-(3), each raw value is divided by the range of the scale on which they are measured, multiplied by a log differentiation factor and subsequently multiplied by a scale conversion factor. The log differentiation factor may be selected to move similar values farther away from one another, which allows small differences to be more clearly shown in the three dimensional space 232. The scale conversion factor may be selected to express the characteristics on a common scale. Results of applying the scaling and normalizing equations 1-3 may be averaged to derive a combined characteristic value for the Alcohol percentage, PH° and Brix°. The resulting average of the normalized values falls within the common scale. The average may be mapped to the radius R in any suitable manner. For example, the radius R may simply be set equal to the average of the normalized values. In this way, the maximum value for the radius R is set by the common scale. Results of the normalizing and scaling of the example characteristic values provided in Table 3 are shown in Table 4 below:

TABLE 4
EXAMPLE SCALED AND NORMALIZED OBJECTIVE
CHARACTERISTIC VALUES (WINE)

| Characteristic | Value |
|---|---|
| Objective | Logarithmic Differentiation Factor = 5, Scale |
| | Conversion Factor = 10 |
| Alcohol Percentage | 6.5 |
| PH° | 9.58 |
| Brix° | 9.95 |
| Average (Radius R Value) | 8.677 |

The aroma value (4.8 out of 8.6) may be similarly mapped to a value for the xy angle θ, for example, according to Equation (4) below:

$$\frac{AromaValue}{ScaleMaximum} = \frac{θ}{360 °} \qquad ( 4 )$$

In the instant example, the xy angle θ is equal to 200.9°. The flavor and balance values from Table 4 may be mapped to the offset O. For example, the flavor and balance values may be expressed on a scale from 1-10. Accordingly, they may simply be averaged and multiplied by a suitable scale representing the maximum allowable offset. For example, when the scale for the radius R is 10, a similar or identical scale may be selected for the offset O. Because the example flavor and balance values are already on a scale from 0-10, no additional scaling is necessary.

FIG. 6 is a diagram illustrating a relationship between dimension values and three-dimensional space 232 depicted on a two-dimensional view 242, such as a two-dimensional screen of a user device 102. It will be appreciated that the various user interfaces described herein may be depicted by a holographic projector or other three-dimensional display device, as a three-dimensional space plotted on a two dimensional screen and/or as a two-dimensional view similar to 242. In FIG. 6, the first and second dimension values again correspond to a radius R and an xy angle θ. Instead of corresponding to an offset on the z-axis, however, the third dimensional variable is expressed as a radius r of the icon 240′. Accordingly, the size of the icon 240′ is used to represent the z-axis offset. For example, offsets representing points farther from the viewer (e.g., negative values on the z-axis, may be represented by relatively smaller radii r, while offsets representing points closer to the viewer (e.g., positive values on the z-axis) may be represented by relatively larger radii r. FIG. 6 also shows a reference circle 244. The reference circle 244 may represent a boundary within which all or most of the measured consumable items will fall. For example, the reference circle 244 may be a graphical representation of the scale conversion factor for the radius R, for example, as indicated in Equations (1)-(3) above. The reference circle 244 may provide the user 103 with an indication of how a particular consumable item (represented by icon 240′) compares to allowable values for other consumable items. FIG. 7 is diagram showing another embodiment of the relationship indicated by FIGS. 5 and 6. In FIG. 7, an icon 240″ is at a different xy angle θ and has a different offset O (which is represented by the radius r). In FIG. 7, the reference circle 244 of FIG. 6 is represented as a reference sphere 245 representing the scale conversion factors of both the characteristics mapped to the radius R and the characteristics mapped to the offset O. FIG. 7 also illustrates a grid 243. The grid may be provided, for example, to indicate to users 103 the position of the icon 240″ relative to permissible positions.

FIGS. 8-10 illustrate additional embodiments of an interface 250 with various icons 252, 254, 256 plotted thereon according to the relationship indicated by FIGS. 5-7. Referring to FIG. 8, the icon 252 indicates a consumable item (e.g., a wine) represented by an aroma characteristic having a normalized value of 1, a bouquet characteristic having a normalized value of 8, a flavor characteristic having a normalized value of 4, and a dryness characteristic having a normalized value of 5. A composite score of 3.3 indicates a weighted average of all of the values described. Weighting factors for generating the weighted average may be selected according to any suitable manner. For example, weighting factors may be selected so as to drive the icon 252, and icons for similar consumable items, to positions on the interface that accentuate relevant differences between the consumable items. Referring to FIG. 9, the icon 254 indicates a consumable item (e.g., a wine) represented by an aroma characteristic having a normalized value of 12, a bouquet characteristic having a normalized value of 12, a flavor characteristic having a normalized value of 9, and a dryness characteristic having a normalized value of 16. A composite score of 11.3 indicates a weighted average of all of the values described. Referring to FIG. 9, the icon 256 indicates a consumable item (e.g., a wine) represented by an aroma characteristic having a normalized value of 1, a bouquet characteristic having a normalized value of 2, a flavor characteristic having a normalized value of 3, and a dryness characteristic having a normalized value of 4. A composite score of 2.3 indicates a weighted average of all of the values described.

FIG. 11 is a diagram illustrating another embodiment of a relationship between dimension values and the three-dimensional space 232. For example, in FIG. 11 the position of the icon 260 (representing a consumable item) is described by a cylindrical coordinate system. A first dimension value R corresponds to a radial distance in the xz plane. A second dimension value φ corresponds to an azimuth angle from the z axis to the position of the icon 260 in the xz plane. A third dimension value H corresponds to a height of the icon 260 above the xz plane. FIG. 12 is a diagram illustrating yet another embodiment of a relationship between dimension values and three-dimensional space 232. For example, in FIG. 12, the position of the icon 262 (representing a consumable item) is described by a spherical coordinate system. A first dimension value R is a radius from the origin 239 to icon 262. A second dimension value φ corresponds to an azimuth angle between the z axis to the position of the icon 262 in the xz plane. A third dimension θ is an inclination angle from the y axis to the position of the icon 262. In embodiments comprising interfaces arranged according to the cylindrical coordinate system shown in FIG. 11 or the spherical coordinate system shown in FIG. 12, the dimension values may be derived from consumable item characteristics in a manner similar to that described above.

Various embodiments of the interfaces described herein may be used to provide comparisons between different consumable items including, for example, different types of wines. FIG. 13 is a flow chart illustrating one embodiment of a process flow 1300 that may be executed in the environment 100 to generate and serve a user interface comparing multiple consumable items. At 1302, the service provider system 104 and/or the user device 102 may receive from a user 103 an indication of a first consumable item (e.g., a first wine). At 1304, the service provider system 104 and/or user device 102 may receive from the user 103 an indication of a second consumable item (e.g., a second wine). Indications of additional consumable items may be received. Optionally, at 1306, the service provider system 104 and/or user device 102 may generate the interface including icons representing the received consumable items. The interface may be generated, for example, as described herein above including with reference to FIGS. 3 and 5. In embodiments where the interface is not generated on the fly, the service provider system 104 and/or user device 102 may instead, at 1308, receive values for populating the user interface including, for example, dimension values for each of the consumable items to be represented. The values may be provided, for example, from the data store 109. At 1310, the service provider system 104 and/or user device 102 may serve the resulting interface to the user 103.

FIGS. 14 and 15 are diagrams showing embodiments of an interface 266 showing icons in the three dimensional space representing multiple consumable items. FIG. 14 illustrates icons 268, 270, 272, 274, 276, 278, with each representing a consumable item. FIG. 15 illustrates icons 282, 284, 286, 288, 290, 292, 294, 296, 298, again with each representing a consumable item. Both instances of the interface 266 show the reference sphere 245, as described herein above.

In various embodiments, the service provider system 104 and/or user device 102 is programmed to conduct a search that receives a consumable item as a search parameter. For example, given an input consumable item, the relevant system identifies and plots similar consumable items. This functionality may be useful, for example, to users 103 who like one variety of consumable item (a particular type of wine) and want to identify similar consumable items that they may also like. FIG. 16 is a flow chart showing one embodiment of a process flow 1600 that may be executed in the environment 100 to perform a search based on a consumable item (e.g., a comparative search). At 1602, the service provider system 104 and/or user device 102 receives a request for a consumable item-based search. For example, the user 103 may indicate an input consumable item to be an input parameter to the search. At 1604, the service provider system 104 and/or user device 102 executes the search. The search may be executed in any suitable manner. For example, in some embodiments, the service provider system 104 and/or user device 102 identifies other consumable items having values for the various measured characteristics similar to those of the input consumable item. The distance between two consumable items, for example, may be expressed as a least squares or other estimation of the distance between the characteristic values for the two consumable items. The search may return consumable items within a threshold distance of the input consumable item, a predetermined number of the closest consumable items, etc. Also, in some embodiments, the service provider system 104 and/or user device 102 identifies other consumer items having similar values based on the position of the items' respective icon positions in the three dimensional space. This may involve, for example, finding an absolute value of distance in the three dimensional space between the input consumable item and various potentially similar consumable items.

When consumable items similar to the identified consumable item are identified, the service provider system 104 and/or user device 102 may generate and serve a user interface plotting the returned consumable items. FIG. 17 is a diagram illustrating one embodiment of an interface 300 indicating results of a comparative search. The interface 300 comprises a field 302 comprising an icon 304 representing the input consumable item. A field 303 includes icon 304 representing the input consumable item and additional icons 306, 308, 310, 312 indicating consumable items returned as similar to the input consumable item.

As described herein, additional properties (e.g., shape, color, etc.) of the various icons plotted in three-dimensional space may indicate various other characteristics of the consumable items. In some embodiments, icons may be configured to represent characteristics having proportional values. For example, FIG. 18 is a diagram illustrating one embodiment of an interface showing an icon 322 having a proportional characteristic (e.g., aroma) represented by icon color (as illustrated, a ratio of icon colors). In the example of FIG. 18, the characteristic illustrated by the icon 322 is aroma. For example, an interface plotting the icon 322 in three dimensional space may map characteristics other than aroma to the various dimension values. In various embodiments, the aroma characteristic may be expressed as percentages of different aroma types. For example, the consumable item (e.g., wine) represented by icon 322 has an aroma that is 15.00% caramel, 5.00% phenolic, 20.00% tropical fruit, and 60% tree fruit. Numeric information representing the icon 322 is provided in an information field 321. Although aroma is displayed by the icon 322, it will be appreciated that any proportional characteristic could be represented. For example, proportional characteristics may include alcohol versus non-alcohol percentages, grape variety mix percentages, etc. Also, although the icon 322 represents portions as wedges, portions may be similarly represented as lines, stripes or any other visual indicator.

The icon 322 may be plotted in any of the interfaces described herein at any of the positions described herein. For example, FIG. 19 is a diagram showing one embodiment of an interface 330 plotting the icon 322 of FIG. 18 in a comparative search result similar to that shown in the interface 300 of FIG. 17. For example, the interface 330 comprises a field 332 comprising the icon 322 representing the input consumable item, and illustrating its aroma. A field 334 includes the icon 322 and additional icons 336, 338, 340, 342 indicating consumable items returned as similar to the input consumable item 322. FIGS. 20-23 are diagrams showing additional embodiments of the interface 320 of FIG. 18 showing icons having a characteristic (e.g., aroma) represented by an icon color. FIG. 20 shows an icon 350 corresponding to a consumable item having an aroma that is 100.00% fruity. FIG. 21 shows an icon 352 corresponding to a consumable item having an aroma that is 70.00% tree fruit and 30.00% tropical fruit. FIG. 22 shows an icon 352 corresponding to a consumable item having an aroma that is 15.00% caramel, 60.00% tree fruit and 25.00% tropical fruit. FIG. 23 shows an icon 356 corresponding to a consumable item having an aroma that is 20.00% lemon and 50.00% fruity.

Although the various interfaces described herein above plot icons in three-dimensional space, it will be appreciated that some embodiments may plot icons in only two dimensions. For example, consumable item characteristics may be mapped to two dimension values instead of three. The two dimensional values may be, for example, x and y coordinate values, polar coordinate values, etc.

FIGS. 24-25 are diagrams illustrating one embodiment of an additional interface 400 for providing information regarding consumable items to users. For example, the interface 400 comprises a radar plot 400 illustrating various consumable item characteristics. The characteristics may be scaled to a common scale, as illustrated. Values for each characteristic may be plotted on respective axes radiating from a center 402. FIG. 25 illustrates an alternate embodiment of the interface 400 where the axes of FIG. 24 are replaced by wedges. The filled-in portions of each wedge correspond to scaled values for corresponding consumable item characteristics. FIG. 26 is a diagram illustrating one embodiment of yet another interface 500 for providing information regarding consumable items to users. In FIG. 26, various consumable item characteristics are represented in a plane 502. Values for each characteristic are indicated by a height in the direction indicated by the arrow 504, resulting in the topographical chart 501. For the interface 500, the characteristics may be scaled and/or normalized in any suitable manner.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference in the specification to “one embodiment,” “various embodiments,” or to “an example embodiment” means that a particular feature, structure, or characteristic described in connection with the example embodiments is included in at least one example embodiment of the invention. The appearances of the phrase “in one embodiment” in various places in the specification are not necessarily all referring to the same example embodiment. Reference to example embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient, at times, principally for reasons of common usage, to refer to these signals as bits, values, elements, symbols, characters, terms, numbers, or the like. Furthermore, it is also convenient, at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred example embodiment and several alternate example embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A system for characterizing consumable items, the system comprising:
a computer system comprising at least one processor and operatively associated memory, wherein the computer system is programmed to:
receive a plurality of characteristics describing a first consumable item;
derive a first dimension value from a first set of the plurality of characteristics;
derive a second dimension value from a second set of the plurality of characteristics;
derive a third dimension value from a third set of the plurality of characteristics;
for a third at least one characteristic selected from the plurality of characteristics, derive a third dimension value; and
generate a user interface, wherein the user interface depicts a three-dimensional space and comprises an icon representing the first consumable item, wherein generating the user interface comprises positioning the icon in the depicted three-dimensional space at a position corresponding to the first, second and third dimension values.

2. The system of claim 1, wherein the first set of the plurality of characteristics consists of one characteristic.

3. The system of claim 1, wherein generating the user interface further comprises deriving a color of the icon based on a fourth at least one characteristic selected from the plurality of characteristics.

4. The system of claim 1, wherein generating the user interface further comprises plotting on the icon a graphical indication of a ratio representing a fourth at least one characteristic selected from the plurality of characteristics.

5. The system of claim 1, wherein the three-dimensional space is defined with reference to a first axis, a second axis orthogonal to the first axis and a third axis orthogonal to the first axis and the second axis, wherein the first, second and third axes meet at an origin, and wherein:
the first dimension value is a distance of the icon from the origin in a plane defined by the first and second axes;
the second dimension value is an angular position of the icon about the first axis and measured from the second axis; and
the third dimension value is an offset of the icon along the third axis.

6. The system of claim 5, wherein the user interface depicts the three-dimensional space as an approximation in two dimensions, and wherein positioning the icon in the three-dimensional space at the position corresponding to the first, second and third dimension values comprises selecting a size of the icon proportional to the offset of the icon along the third axis.

7. The system of claim 1, wherein the three-dimensional space is defined with reference to a first axis, a second axis orthogonal to the first axis and a third axis orthogonal to the first axis and the second axis, wherein the first, second and third axes meet at an origin, and wherein:
the first dimension value is a distance of the icon from the origin;
the second dimension value is a polar angle indicating an angle between the icon and the second axis; and
the third dimension value is an azimuth angle indicating an angle between the third axis an orthogonal projection of a line from the origin to the icon onto an axis comprising the first axis and the third axis.

8. The system of claim 1, wherein the computer system is further programmed to:
receive a request to identify consumable items similar to the first consumable item; and
select a second consumable item based on a distance between a plurality of characteristics describing the second consumable item and the plurality of characteristics describing the first consumable item;
modify the user interface to display a second icon representing the second consumable item, wherein the position of the second icon is based on first, second and third dimension values of the second consumable item.

9. The system of claim 1, wherein the computer system is further programmed to:
receive a request to identify consumable items similar to the first consumable item; and
select a second consumable item based on a distance between the icon and a second icon representing a plurality of characteristics describing the second consumable item according to first, second and third dimension values;
modify the user interface to display a second icon representing the second consumable item, wherein the position of the second icon is based on the first, second and third dimension values of the second consumable item.

10. The system of claim 1, wherein the first at least one characteristic comprises a more than one characteristic, and wherein deriving the first dimension value further comprises normalizing the more than one characteristic.

11. A method for characterizing consumable items, the method comprising:
receiving, by a computer system, a plurality of characteristics describing a first consumable item, wherein the computer system comprises at least one processor and operatively associated memory;
deriving, by the computer system, a first dimension value from a first set of the plurality of characteristics;
deriving, by the computer system, a second dimension value from a second set of the plurality of characteristics;
deriving, by the computer system, a third dimension value from a third set of the plurality of characteristics; and
generating a user interface, wherein the user interface depicts a three-dimensional space and comprises an icon representing the first consumable item, wherein generating the user interface comprises positioning the icon in the depicted three-dimensional space at a position corresponding to the first, second and third dimension values.

12. The method of claim 11, wherein the first set of the plurality of characteristics consists of one characteristic.

13. The method of claim 11, wherein generating the user interface further comprises deriving a color of the icon based on a fourth at least one characteristic selected from the plurality of characteristics.

14. The method of claim 11, wherein generating the user interface further comprises plotting on the icon a graphical indication of a ratio representing a fourth at least one characteristic selected from the plurality of characteristics.

15. The method of claim 11, wherein the three-dimensional space is defined with reference to a first axis, a second axis orthogonal to the first axis and a third axis orthogonal to the first axis and the second axis, wherein the first, second and third axes meet at an origin, and wherein:
the first dimension value is a distance of the icon from the origin in a plane defined by the first and second axes;
the second dimension value is an angular position of the icon about the first axis and measured from the second axis; and
the third dimension value is an offset of the icon along the third axis.

16. The method of claim 15, wherein the user interface depicts the three-dimensional space as an approximation in two dimensions, and wherein positioning the icon in the three-dimensional space at the position corresponding to the first, second and third dimension values comprises selecting a size of the icon proportional to the offset of the icon along the third axis.

17. The method of claim 11, wherein the three-dimensional space is defined with reference to a first axis, a second axis orthogonal to the first axis and a third axis orthogonal to the first axis and the second axis, wherein the first, second and third axes meet at an origin, and wherein:
the first dimension value is a distance of the icon from the origin;
the second dimension value is a polar angle indicating an angle between the icon and the second axis; and
the third dimension value is an azimuth angle indicating an angle between the third axis an orthogonal projection of a line from the origin to the icon onto an axis comprising the first axis and the third axis.

18. The method of claim 11, further comprising:
receive a request to identify consumable items similar to the first consumable item; and
select a second consumable item based on a distance between a plurality of characteristics describing the second consumable item and the plurality of characteristics describing the first consumable item;
modify the user interface to display a second icon representing the second consumable item, wherein the position of the second icon is based on first, second and third dimension values of the second consumable item.

19. The method of claim 11, further comprising:
receive a request to identify consumable items similar to the first consumable item; and
select a second consumable item based on a distance between the icon and a second icon representing a plurality of characteristics describing the second consumable item according to first, second and third dimension values;
modify the user interface to display a second icon representing the second consumable item, wherein the position of the second icon is based on the first, second and third dimension values of the second consumable item.

20. The method of claim 11, wherein the first at least one characteristic comprises a more than one characteristic, and wherein deriving the first dimension value further comprises normalizing the more than one characteristic.

21. A system for characterizing consumable items, the system comprising:
a computer system comprising at least one processor and operatively associated memory, wherein the computer system is programmed to:
receive a plurality of characteristics describing a first consumable item;
normalize the plurality of characteristics to a common scale;
generate a user interface, wherein the user interface defines a center, wherein each of the plurality of characteristics corresponds to an angular position about the center, and wherein each of the plurality of characteristics is indicated by a marker such that a distance from the marker to the center indicates a value of the corresponding characteristic.

22. A method for characterizing consumable items, the method comprising:
receiving, by a computer system, a plurality of characteristics describing a first consumable item, wherein the computer system comprises at least one processor and operatively associated memory;
normalizing, by the computer system, the plurality of characteristics to a common scale;
generating, by the computer system, a user interface, wherein the user interface defines a center, wherein each of the plurality of characteristics corresponds to an angular position about the center, and wherein each of the plurality of characteristics is indicated by a marker such that a distance from the marker to the center indicates a value of the corresponding characteristic.
